(19) United States
(12) Patent Application Publication
(10) Pub. No.: US 2025/0191802 A1
(43) Pub. Date: Jun. 12, 2025

(54) Induced Integral Clustering in Metastable Chain States Within a Quantum Capillary Lattice

(71) Applicants: Rodolfo Carrera, Austin, TX (US); Elena Montalvo, Austin, TX (US)

(72) Inventors: Rodolfo Carrera, Austin, TX (US); Elena Montalvo, Austin, TX (US)

(21) Appl. No.: 18/534,343

(22) Filed: Dec. 8, 2023

(51) Int. Cl. G21K 1/00

(52) U.S. Cl. CPC G21K 1/003

(57) ABSTRACT

A method and system including introducing one or more types of nuclei into a cavity of a capillary and sending a current pulse along at least one of one or more conductors surrounding the cavity of the capillary. The current pulse is configured to generate a magnetic field pulse within the cavity. Furthermore, a positive voltage is applied to at least one of the one or more conductors surrounding the capillary. The one or more types of nuclei are bounded-chain focalized along an axis of the cavity of the capillary based at least on sending the current pulse and applying the positive voltage. The one or more types of nuclei interact, based at least on being bounded-chain focalized, and generate one or more resulting types of nuclei. The one or more resulting types of nuclei acquire kinetic energy, based at least on the one or more types of nuclei interacting.

### A. BACKGROUND

The invention relates generally to inducing integral clustering in metastable chain states.

### B. BRIEF DESCRIPTION OF THE DRAWINGS

Other objects and advantages of the invention may become apparent upon reading the detailed description and upon reference to the accompanying drawings.

FIG. 1 is a quantum capillary lattice micromodule having a plurality of quantum capillaries, in accordance with some embodiments.

FIG. 2 is a side view of a quantum capillary lattice micromodule, in accordance with some embodiments.

FIG. 3 is a vertical cross-sectional view of a quantum capillary lattice micromodule, in accordance with some embodiments.

FIG. 4 is a horizontal cross-sectional view of an anode of a quantum capillary lattice micromodule, in accordance with some embodiments.

FIG. 5 is a second horizontal cross-sectional view of a cathode of a quantum capillary lattice micromodule, in accordance with some embodiments.

FIG. 6 is a side view and a cross-sectional view of a quantum capillary, in accordance with some embodiments.

FIG. 7 is a diagram of a capillary electrical circuit, in accordance with some embodiments.

FIG. 8 is a graph of a current pulse supplied to a conductive layer of a capillary, in accordance with some embodiments.

FIG. 9 is another diagram of a quantum capillary electrical circuit, in accordance with some embodiments.

FIG. 10 is a diagram of an electrical circuit of ring electrodes at the orifices of a quantum capillary, in accordance with some embodiments.

FIG. 11 is a block diagram of an anode and charged-coupled cathode electrical circuit, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### C. DETAILED DESCRIPTION

It should be noted that the devices shown are not necessarily to scale, the number of features shown are exemplary, and the dimensions shown are also exemplary.

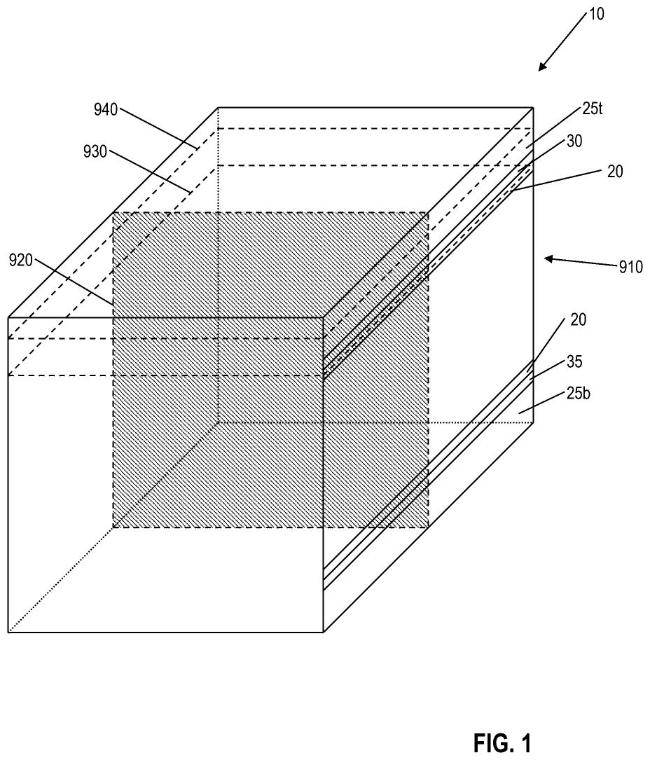

FIG. 1 is a quantum capillary lattice micromodule having a plurality of quantum capillaries, in accordance with some embodiments.

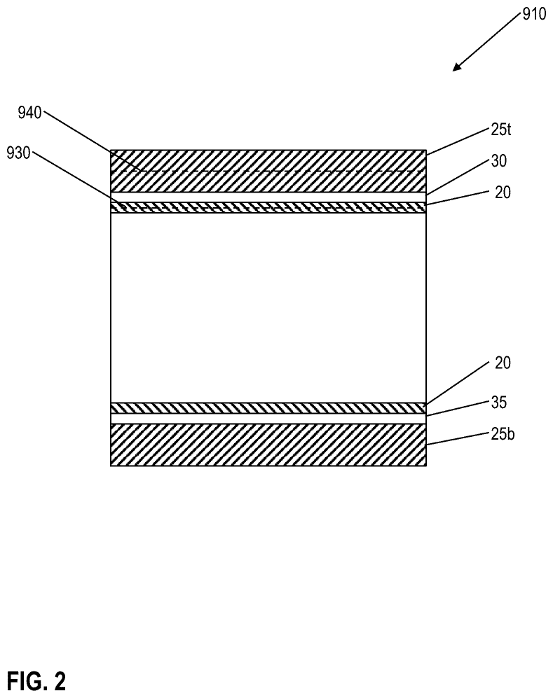

FIG. 2 is a side view of a quantum capillary lattice micromodule, in accordance with some embodiments.

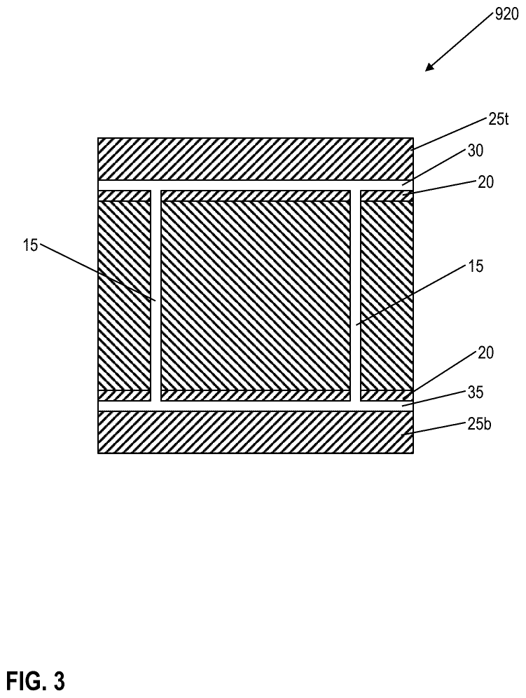

FIG. 3 is a vertical cross-sectional view of a quantum capillary lattice micromodule, in accordance with some embodiments.

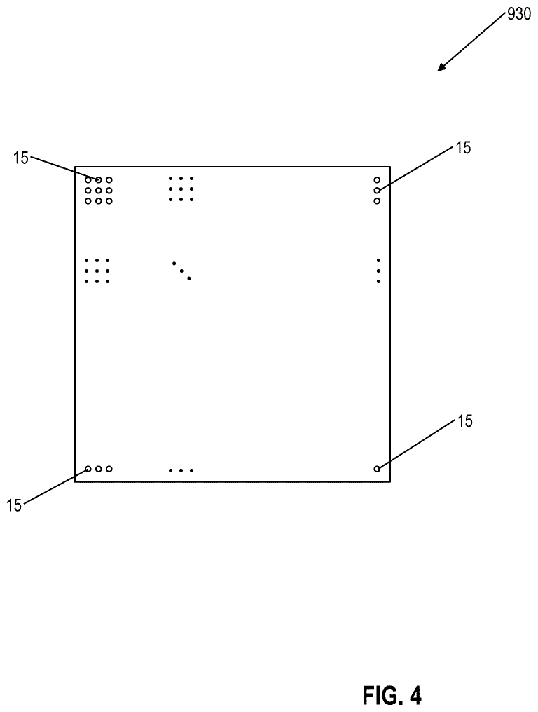

FIG. 4 is a horizontal cross-sectional view of an anode of a quantum capillary lattice micromodule, in accordance with some embodiments.

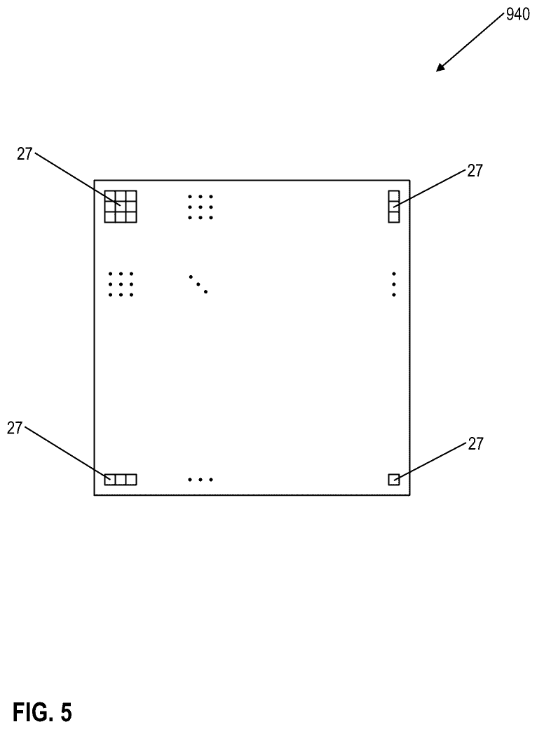

FIG. 5 is a second horizontal cross-sectional view of a cathode of a quantum capillary lattice micromodule, in accordance with some embodiments.

FIG. 2 shows side view 910 of quantum capillary lattice micromodule 10, in accordance with some embodiments.

FIG. 3 shows vertical cross-sectional view 920 of quantum capillary lattice micromodule 10, in accordance with some embodiments.

FIG. 4 shows horizontal cross-sectional view 930 of anode 20 of quantum capillary lattice micromodule 10, in accordance with some embodiments.

FIG. 5 shows horizontal cross-sectional view 940 of cathode 25 of quantum capillary lattice micromodule 10, in accordance with some embodiments.

In some embodiments, quantum capillary lattice micromodule 10 comprises an anode 20 and a cathode 25. In some embodiments, micromodule 10 may include anode 20, and two cathodes, a top cathode 25t and a bottom cathode 25b (collectively referred to as cathode 25).

In some embodiments, micromodule 10 comprises gas inlet 35 and gas inlet 30. In some embodiments, particles (for example, atoms) that are to interact within micromodule 10 (to generate electricity, for example) may be supplied by a supply source and enter micromodule 10 through gas inlets 30 and 35.

In some embodiments, micromodule 10 comprises a plurality of quantum capillaries 15. In some embodiments, capillaries 15 may be arranged vertically in an array (for example, a 100×100 array of capillaries) within micromodule 10.

In some embodiments, cathode 25 may be a split charge-coupled cathode with surface pixel structures 27 (for example, a 100×100 array of surface pixel structures) corresponding to and aligned with, for example, the 100×100 capillaries 15. Cathode 25 and anode 20 may be configured to generate electricity (as will be discussed in more detail below) and are thus also configured to be coupled to an external load, for example.

In some embodiments, the integrated micromodule may be designed with a volume of 1 cm³ and a total capillary surface ≈1 cm². In some embodiments, each anode may include approximately 104 capillaries per cm² having a length of ≈10 mm and a diameter of ≈100 nm. In some embodiments, the separation distances of anode capillaries and cathode pixel structures are ≈100 μm.

In some embodiments, the quantum capillaries array is fed by a regulated near normal temperature and pressure (NTP) gas mix flow.

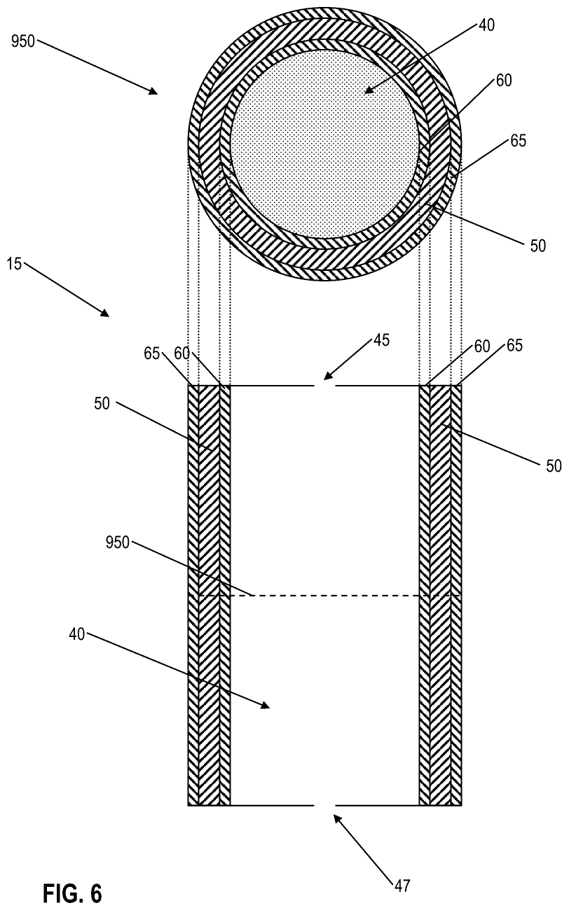

FIG. 6 is a side view and a cross-sectional view of a quantum capillary, in accordance with some embodiments.

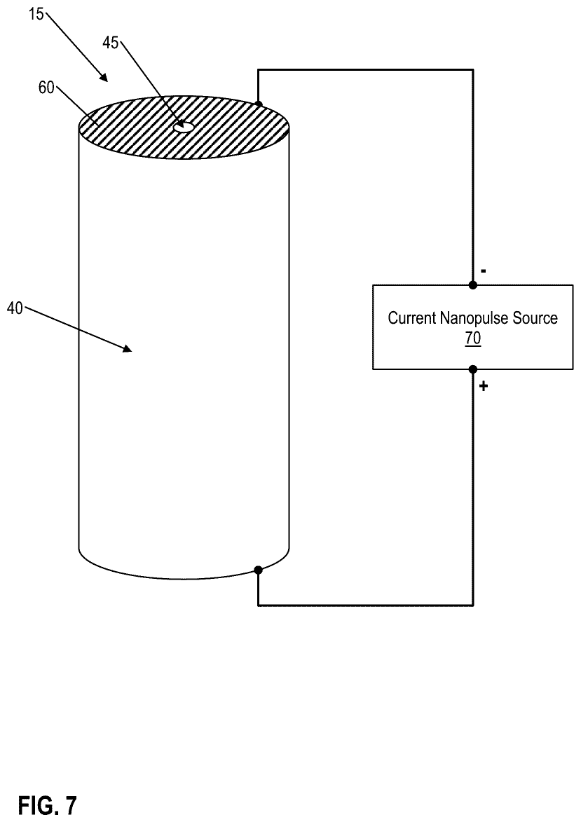

FIG. 7 is a diagram of a capillary electrical circuit, in accordance with some embodiments.

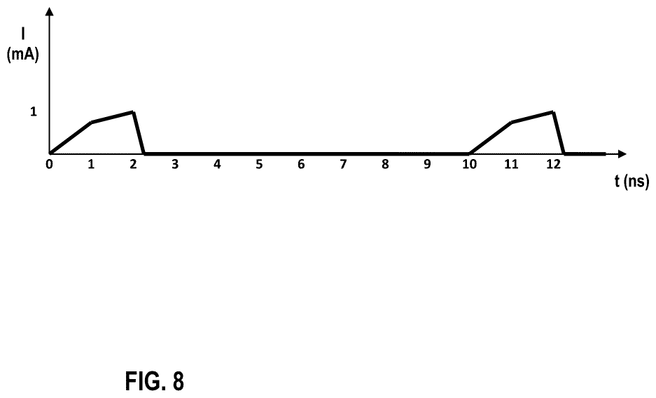

FIG. 8 is a graph of a current pulse supplied to a conductive layer of a capillary, in accordance with some embodiments.

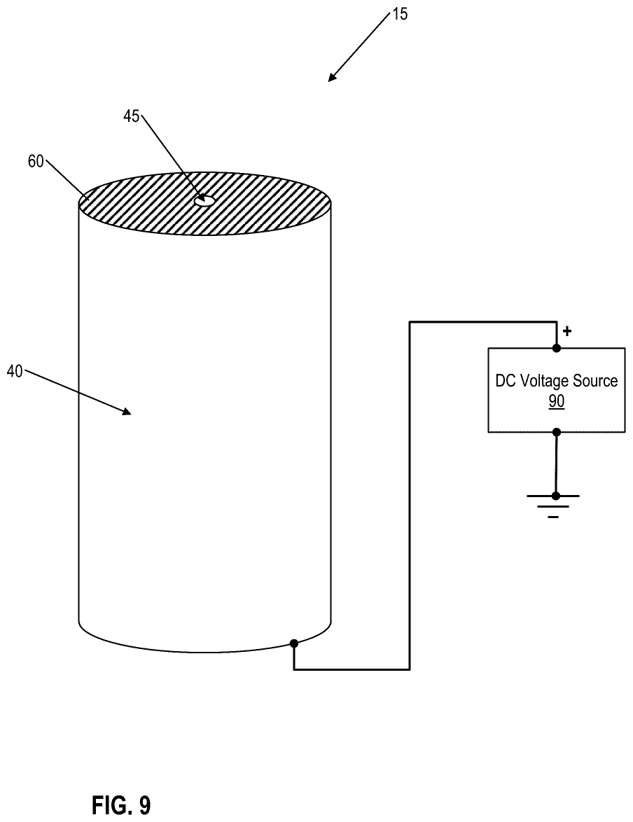

FIG. 9 is another diagram of a quantum capillary electrical circuit, in accordance with some embodiments.

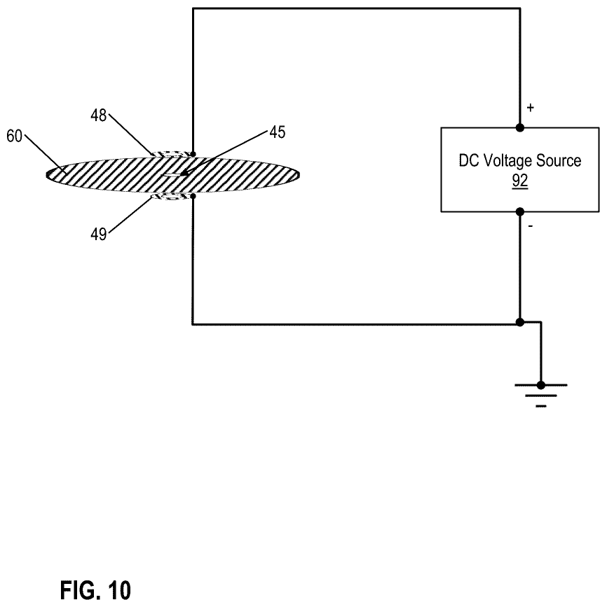

FIG. 10 is a diagram of an electrical circuit of ring electrodes at the orifices of a quantum capillary, in accordance with some embodiments.

In some embodiments, capillary 15 (which may be one of many in an array of capillaries within micromodule 10, for example) may comprise a conductor such as conductive layer 60, which may be a cylindrical conductive layer, made of graphene-type or similar material, for example. In some embodiments, any conductive material may be used having a very low resistivity. Another example of such conductive material would be multi-walled carbon nanotubes.

In some embodiments, conductive layer 60 may extend to the top and bottom bases of capillary 15. In alternative embodiments, a separate conductive layer may be used at the top and bottom bases or at the lateral side of capillary 15. In some embodiments, conductive layer 60 defines cavity 40 within capillary 15.

In alternative embodiments, conductive layer 60 may generally be any conductor in the vicinity/near and/or surrounding capillary 15 such as one or more wires, one or more coiled wires, etc. In yet other alternative embodiments, multiple conductors may be used.

In some embodiments, capillary 15 comprises a magnetic reflector such as magnetic reflective layer 50 to the outside and laterally surrounding conductive layer 60. In some embodiments, reflective layer 50 is configured to provide a magnetically reflective boundary as will be discussed further below. In some embodiments, capillary 15 may also comprise insulating layer 65 to the outside and surrounding reflective layer 50. In some embodiments, conductive layer 60, reflective layer 50, and insulating layer 65 may be referred to collective as a multilayer clad surrounding capillary 15.

In some embodiments, capillary 15 comprises two nano-orifices: orifice 45 and orifice 47 respectively at the top and bottom of capillary 15. Orifice 45 and orifice 47 may be connected to a regulated source of gas (in some embodiments near normal temperature and pressure) made of atoms whose nuclei are to interact inside capillary 15. For example, the gas may comprise low atomic number atoms, such as ¹¹B⁵⁺ and ¹H¹, at near normal temperature and pressure (NTP) conditions. Other types of atoms may be used including atoms of the same type, atoms of two or more different types, etc.

In some embodiments, the capillary may contain a non-equilibrium ensemble of a billion particles. In some embodiments, capillary 15 may have a diameter of 100 nm with orifice 45 orifice 47 having diameters of 10 nm (which may be in the order of the gas particle interspacing distance). Capillary 15 may have a length/height of 10 mm and may be embedded within an integrated quantum capillary lattice made of similar capillaries within micromodule 10.

In some embodiments, conductive layer 60 is configured to be coupled to current nanopulse source 70, as is shown in FIG. 7, for example. Nanopulse source 70 is configured to generate a pulsed current axially oriented via conductive layer 60, with the pulsed current generating a cylindrical (in embodiments where the conductive layer is cylindrical) magnetic wavefront that converges, after being reflected from reflective layer 50, radially inwards toward the axis of cavity 40 of capillary 15. As discussed above, conductive layer 60 may have other shapes, and as such, magnetic field wavefronts/pulses with alternative profiles may be generated. In alternative embodiments, the current pulse may be sent to one or more of multiple conductors in near capillary 15.

An example profile of the pulsed current is shown in FIG. 8. In some embodiments, the conductive layer 60 bounded-chain focalization pulse may have a current maximum of 1 mA, a voltage of 10 V, and a duration of 1 ns with a ramp up of 1 ns. In some embodiments, every 10 ns, the current pulse may be then sequentially cycled through the other capillaries (100×100, in some embodiments) of micromodule 10. Thus, the pulse, in such embodiments, may be repeated in each capillary every 100 μs. In some embodiments, the pulse current density may be in the order of 108 A/cm².

In some embodiments, DC voltage source 90 is configured to be connected to conductive layer 60 as is shown in FIG. 9. In some embodiments, the positive of DC voltage source 90 may be connected to the bottom (or any other portion) of conductive layer 60 and the negative may be connected to ground. In alternative embodiments, an electric field profile around the cavity can be generated/established with DC and/or AC voltage sources and/or voltage sources with other profiles. In alternative embodiments, connections may be made to the top and bottom of conductive layer 60. Other configurations may also be used depending on the number and locations of the conductors present near capillary 15. In some embodiments, the positive bias voltage applied to conductive layer 60 is configured to generate electric fields that, at least in part, maintain the nuclei within cavity 40 during their interaction. As discussed above, conductive layer 60 may have other shapes, and as such, electric fields with alternative profiles may be generated. It should also be noted that the magnetic field pulse/wavefront and the electric fields may be generated using separate conductors/conductive layers. In alternative embodiments, positive voltage may be applied to one or more of the multiple conductors near capillary 15 or electric field profiles may be generated in alternative methods.

In some embodiments, ring electrodes may be placed above and below orifice 45 and orifice 47. FIG. 10 shows electrode 48 and electrode 49 above and below orifice 45. Similar electrodes may be placed above and below orifice 47 (not shown).

In some embodiments, DC voltage 92 may be connected across each pair of electrodes. In some embodiments, the positive of DC voltage source 92 may be connected to outside electrode 48 (and to the outside of the bottom electrode) and the negative of DC voltage source 92 may be connected to inside electrode 49 (and to the inside of the bottom electrode). It should be noted that, in some embodiments, DC voltage source 90 and DC voltage source 92 may be the same DC voltage source.

In some embodiments, the applied voltage is configured to generate a high electric field at orifice 45 and orifice 47 based at least on the ring electrodes having thin walls. In some embodiments, the ring electrodes may have walls having a thickness in the order of 100 μm.

In some embodiments, as atoms in the gas diffuse into cavity 40 of capillary 15 through orifice 45 and orifice 47, the high electric field generated by the ring electrodes near orifice 45 and orifice 47 is configured to remove the electrons from the particles/atoms (through field absorption, for example) creating nuclei.

In some embodiments, a DC bias voltage in the order of 10 V may be applied. In some embodiments, an electron of an atom passing through an orifice experiences a perimeter-integrated electric field in the order of 10 GV/cm.

It should be noted that the electrons may be removed using alternative methods. For example, electrons may be removed from the entering gas atoms using high electric fields generated directly at orifice 45 and orifice 47 by the bias voltage applied to conductive layer 60.

In some embodiments, filling by pressure balance through the orifices maintains capillary's cavity particle number after operational losses. In some embodiments, a particle flow may be maintained through capillary 15 in order to replace particles that have already interacted and been consumed as will be seen below. In some embodiments, a flow in the order of 0.1 picoliter/s may be maintained with a particle orifice pass-through period in the order of 1 ns.

In some embodiments, transient 1D-space ordering of the capillary free particles may be induced by the current nanopulse in conductive layer 60 and held, at least partially, within cavity 40 by the DC bias voltage. The particle nanocloud within cavity 40 may radially and reversibly oscillate between singularly bounded-chain focalized (with the current pulse on) and outset nanocloud states (with the current pulse off).

In some embodiments, the current pulse through conductive layer 60 generates a radial magnetic wavefront of uniform cylindrical (in embodiments where the conductive layer is cylindrical) intensity and timing. Conductive layer 60 may act as a space and time lens leading to singular bounded-chain focalization (that is, axis-symmetric bounded-chain focalization to sub-picometer 1D ordering on the axis of cavity 40).

In some embodiments, the ultrafast azimuthal magnetic field pulse created by the pulsed current is reflected inward by reflective layer 50 that acts as a focusing lens. Throughout the pulse, the particle nanocloud is radially bounded-chain focalized by the wavefront and is axially bounded on the axis of cavity 40 by the electric fields at orifice 45 and at orifice 47 generated by the bias voltage. In some embodiments, bounded-chain focalization may be a radial process (with axial uniformity and angular isotropy), constraining the nuclei nanocloud to an axial 1D chain.

In some embodiments, the bounded-chain focalization pulse has a peripheral wavefront pressure in the order of 10 mPa at the lateral surface of cavity 40. In some embodiments, the pulse's energy is focused simultaneously on the cavity axis where the nuclei nanocloud may be ordered in 1D along the axis of cavity 40.

In some embodiments, the wavefront's radial convergence counters the increasing doublet nuclei coulomb repulsion. The force exerted by the wavefront may be larger than the doublet nuclei coulomb repulsion force making it possible for an interaction through quantum tunnelling of the nuclei particles within cavity 40.

In some embodiments, during the bounded-chain focalization process, the nanocloud may be in a 1D state (with the nuclei radial distribution going from approximately 100 nm nanocloud to a less than a 1 μm linear chain).

In embodiments where the gas atoms introduced into capillary 15 are ¹H¹ and ¹¹B⁵⁺ atoms, the bounded-chain focalization of the nanocloud induces degenerate ¹H¹⁺ and ¹¹B⁵⁺ pairs in 1D space along the axis of cavity 40. In some embodiments, the lifetime of the induced metastable bound pair state (and associated metastable linear chain state) may be in the order of 1 ns. Bounded-chain focalization allows localized states with pair chain configuration within an axial 1D space with sub-picometer radial extent.

In some embodiments, the nanocloud focusing force in the 1D space may be in the order of 1 mN, which is larger than the value of the repulsion force between the constrained doublet nuclei, which is in the order of 10 μN. The pairs may be axially separated by ≈10 μm (each pair constrained by two contiguous pairs) with their repulsion force being in the order of 100 μN balanced by each pair inner repulsion force.

In some embodiments, it may be energetically favorable for a ¹H¹⁺ nucleus to intercalate between a ¹¹B⁵⁺ nucleus and a contiguous ¹¹B⁵⁺ nucleus in the 1D space. Doublet charge-asymmetry may induce ordering of the fixed-length 1D distribution, intercalating each of the ¹H¹⁺ nuclei between two ¹¹B⁵⁺ nuclei. The bounded-chain focalized 1D intercalate order distribution forms a force-balance bounded-chain focalization-driven ¹H¹⁺−¹¹B⁵⁺ nuclei pair chain (a bounded periodic 1D linear ordering of ¹H¹⁺−¹¹B⁵⁺ nuclei pairs along the capillary axis) within the radial extent of pair bounded-chain focalization.

In some embodiments, the ¹H¹⁺−¹¹B⁵⁺ nuclei pair linear chain may be sustained by the electric field induced at orifice 45 and orifice 47, with fixed axial boundary conditions during the pulse flat top. In some embodiments, the electric field generated by the capillary thin-edged orifices near their center balance out the nuclei pairs linear chain repulsion force, which may be in the order of 100 μN.

In some embodiments, pair chain bounding may occur on axis where the electric field repulsion force applied to axial linear chain boundaries has a symmetric contribution from the entire equidistant orifice perimeter during the nanopulse.

In embodiments where the gas atoms introduced into capillary 15 are ¹H¹ and ¹¹B⁵ atoms, spontaneous bounded-chain focal cell 1D-space ordering proceeds with bounded-chain focal cell degeneration via collective doublet-to-pair quantum transitioning. At radial extent of pair bounded-chain focalization, doublet axial intercalation, coulomb force balancing, and wavefunction overlapping, induce degenerate pairing with pair chain formation (time scale in the order of 1 as).

As such, bounded-chain focalization may drive the ensemble nuclei in a metastable repeating pattern of pair degenerate pair states that hold during the pulse (in the order of 1 ns in duration), and where quantum tunneling is mediated by chain pair coulomb force balance. Residual strong interaction on the chain pair nuclei may induce some integral ⁴He²⁺ cluster states that undergo triplet split decaying by emission of three charge carriers ⁴He²⁺ (time scale in the order of 100 μs) in embodiments where ¹H¹⁺ and ¹¹B⁵ nuclei are introduced into cavity 40. In some embodiments, the interaction may be represented as: ¹H¹⁺+¹¹B⁵⁺->3⁴He²⁺.

In some embodiments, quantum tunneling induces the metastable ¹H¹⁺−¹¹B⁵⁺ nuclei pair state to transition into an integral ⁴He²⁺ cluster state mediated by fast residual strong interaction between pair component nucleons. Some of the linear chain pairs form short-lived integral ⁴He²⁺ cluster structures preserving both proton and neutron numbers with no weak interaction involved, that spontaneously decay by triplet splitting into three high energy ⁴He²⁺ charge carriers with average total kinetic energy for the three ⁴He²⁺ in the order of 1 pJ.

In some embodiments, during the pulse, the ¹H¹⁺+¹¹B⁵⁺ nuclei couple to form a 1D quantum pair chain with ≈105⁴He²⁺ cluster quantum states that undergo spontaneous decay by triplet splitting into stable ⁴He²⁺ nuclei of high kinetic energy (average triplet kinetic energy in the order of 1 pJ). The energy source for the emission is the cluster state binding energy mediated by the nucleons' residual strong interaction.

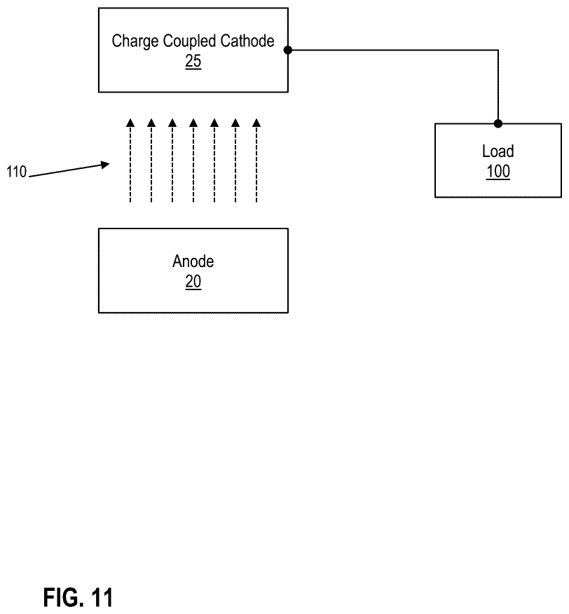

FIG. 11 is a block diagram of an anode and charged-coupled cathode electrical circuit, in accordance with some embodiments.

In some embodiments, the charged carriers 110 resulting from the nuclear interaction and emerging from anode 20 may be converted into electricity via a charged couple cathode device 25. The electricity may be then utilized by load 100.

In embodiments where the interactions are between ¹¹B⁵⁺ and ¹H¹⁺ nuclei, the resulting ⁴He²⁺ nuclei triplets may be emitted with average kinetic energy in the order of ≈1 pJ from an average ¹H¹⁺−¹¹B⁵⁺ nuclei pair average kinetic energy being in the order of ≈10 aJ.

In some embodiments, the high kinetic energy ⁴He²⁺ nuclei streamline (with emission radial motion conversion to axial motion through energy barrier interaction) to the split cathode 25 top-bottom surfaces out of capillary 15 axis and thus being unimpeded by the edge electric field in the capillary's 15 orifices.

In some embodiments, the ⁴He²⁺ nuclei streamline toward the charged coupled cathode 25 and strike cathode 25. In some embodiments, a grid of pixel structures may exist for each micromodule 10.

As a result, electrons are dislodged in the thin charge-coupled cathode pixel structures by the high kinetic energy ⁴He²⁺ nuclei and are collected by semiconductor junctions for subsequent release, generating a direct electronic current and thus electricity.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method comprising:
introducing one or more types of nuclei into a cavity of a capillary;
sending a current pulse through at least one of one or more conductors, wherein the current pulse is configured to generate a magnetic field pulse within the cavity;
applying a positive voltage to at least one of the one or more conductors;
causing a focalization of the one or more types of nuclei based at least on the sending the current pulse and the applying the positive voltage;
causing an interaction of the one or more types of nuclei based at least on the focalization; and
causing a generation of one or more resulting types of nuclei based at least on the interaction of the one or more types of nuclei, wherein the one or more resulting types of nuclei acquire kinetic energy.

2. The method of claim 1, wherein the capillary, the cavity of the capillary, and at least one of the one or more conductors are a cylindrical shape, wherein the at least one of the one or more conductors extends to a lateral surface of the cylindrical shape, a top surface of the cylindrical shape, and a bottom surface of the cylindrical shape, and wherein the focalization occurs along a cylindrical axis of the cavity of the capillary.

3. The method of claim 2, wherein the introducing comprises introducing the one or more types of nuclei into the cavity of the capillary through a top orifice of the capillary centered on the cylindrical axis of the cavity and a bottom orifice of the capillary centered on the cylindrical axis of the cavity.

4. The method of claim 1, comprising:
providing a gas of one or more types of atoms;
removing electrons from the one or more types of atoms to yield the one or more types of nuclei.

5. The method of claim 4, wherein the removing the electrons comprises removing the electrons by applying a voltage to electrodes above and below a top orifice of the capillary and to electrodes above and below a bottom orifice of the capillary.

6. The method of claim 4, wherein the removing the electrons comprises removing the electrons by applying the positive voltage to at least one of the one or more conductors.

7. The method of claim 1, comprising causing a reflection of the magnetic field pulse within the cavity using at least one of one or more magnetic reflectors surrounding at least one of the one or more conductors.

8. The method of claim 1, wherein causing a focalization comprises causing a bounded-chain focalization.

9. The method of claim 1, comprising:
causing the one or more resulting types of nuclei to strike onto one or more charge-coupled cathode pixel structures at a top and at a bottom of the cavity based at least on:
the one or more resulting types of nuclei acquiring kinetic energy,
the one or more resulting types of nuclei exiting along either the top or the bottom of the cavity,
causing electrons to dislodge from the charge-coupled cathode pixel structures based at least on the one or more resulting types of nuclei striking onto the one or more charge-coupled cathode pixel structures.

10. The method of claim 9, comprising causing the generation of electricity based at least on the electrons dislodging from the charge-coupled cathode pixel structures.

11. The method of claim 1, wherein the one or more types of nuclei are ¹H¹⁺ nuclei and ¹¹B⁵⁺ nuclei in a one-to-one ratio and wherein the one or more resulting types of nuclei are ⁴He²⁺ nuclei in a three-to-one ratio to the ¹H¹⁺ nuclei and to the ¹¹B⁵⁺ nuclei.

12. A system comprising:
a capillary, wherein the capillary comprises a cavity within the capillary and one or more conductors near the cavity;
a supply source of one or more types of nuclei;
a pulsed current source coupled to at least one of the one or more conductors; and
a voltage source coupled to at least one of the one or more conductors,
wherein:
the cavity is configured to receive the one or more types of nuclei,
the pulsed current source is configured to send a current pulse along at least one of the one or more conductors, wherein the current pulse is configured to generate a magnetic field pulse within the cavity,
the voltage source is configured to apply a positive voltage to at least one of the one or more conductors,
the positive voltage and the magnetic pulse are configured to focalize the one or more types of nuclei and to cause the one or more types of nuclei to interact and to generate one or more resulting types of nuclei acquiring kinetic energy.

13. The system of claim 12, wherein the capillary, the cavity of the capillary, and at least one of the one or more conductors are a cylindrical shape, wherein the at least one of the one or more conductors extends to a lateral surface of the cylindrical shape, a top surface of the cylindrical shape, and a bottom surface of the cylindrical shape, and wherein the positive voltage and the magnetic pulse are configured to focalize the one or more types of nuclei along a cylindrical axis of the cavity of the capillary.

14. The system of claim 12, comprising at least one orifice at either a top or a bottom of the cavity, wherein the one or more types of nuclei are configured to enter into the cavity through the at least one orifice.

15. The system of claim 14, comprising electrodes above and below the orifice, wherein the voltage or another voltage is applied between the electrodes, and wherein the electrodes or at least one of the one or more conductors are configured to remove electrons from one or more types of atoms entering the cavity to yield the one or more types of nuclei.

16. The system of claim 12, comprising at least one magnetic reflector around at least one of the one or more conductors, wherein the at least one magnetic reflector is configured to reflect the magnetic field pulse within the cavity.

17. The system of claim 12, wherein the positive voltage and the magnetic field pulse are configured to bounded-chain focalize the one or more types of nuclei.

18. The system of claim 12, comprising:
one or more charge-coupled cathode pixel structures placed above and/or below the cavity,
wherein charge-coupled cathode pixel structures are configured to be stricken by the one or more resulting types of nuclei and to release electrons generating electricity.

19. The system of claim 18, comprising a load coupled to the one or more charge-coupled cathode pixel structures, and wherein the load is configured to receive the electricity.

20. The system of claim 12, wherein the one or more types of nuclei are ¹H¹⁺ nuclei and ¹¹B⁵⁺ nuclei in a one-to-one ratio and wherein the one or more resulting types of nuclei are ⁴He²⁺ nuclei in a three-to-one ratio to the ¹H¹⁺ nuclei and to the ¹¹B⁵⁺ nuclei.

21. A method comprising:
introducing one or more types of nuclei into a cavity of a capillary;
generating a magnetic field pulse within the cavity;
generating an electric field within the cavity;
causing a focalization of the one or more types of nuclei within the cavity of the capillary based at least on the generating the magnetic field pulse and the generating the electric field;
causing an interaction of the one or more types of nuclei based at least on the focalization; and
causing a generation of one or more resulting types of nuclei based at least on the interaction of the one or more types of nuclei, wherein the one or more resulting types of nuclei acquire kinetic energy.

22. The method of claim 21, wherein the capillary and the cavity of the capillary are cylindrical, and wherein the focalization comprises focalization along a cylindrical axis of the cavity.

23. The method of claim 22, wherein the introducing comprises introducing the one or more types of nuclei into the cavity of the capillary through a top orifice of the capillary centered on the cylindrical axis of the cavity and a bottom orifice of the capillary centered on the cylindrical axis of the cavity.

24. The method of claim 21, comprising:
providing one or more types of atoms;
removing electrons from the one or more types of atoms to yield the one or more types of nuclei.

25. The method of claim 24, wherein the removing the electrons comprises removing the electrons by applying a voltage to electrodes above and below a top orifice of the capillary and to electrodes above and below a bottom orifice of the capillary.

26. The method of claim 24, wherein the removing the electrons comprises removing the electrons by utilizing the electric field.

27. The method of claim 21, comprising causing a reflection of the magnetic field pulse within the cavity using at least one magnetic reflector surrounding the cavity.

28. The method of claim 21, wherein causing a focalization comprises causing a bounded-chain focalization.

29. The method of claim 21, comprising:
causing the one or more resulting types of nuclei to strike onto one or more charge-coupled cathode pixel structures at a top and at a bottom of the cavity based at least on:
the one or more resulting types of nuclei acquiring kinetic energy,
the one or more resulting types of nuclei exiting along either the top or the bottom of the cavity,
causing electrons to dislodge from the charge-coupled cathode pixel structures based at least on the one or more resulting types of nuclei striking onto the one or more charge-coupled cathode pixel structures placed at either or both ends of the axis of the cavity of the capillary.

30. The method of claim 29, comprising causing the generation of electricity based at least on the electrons dislodging from the charge-coupled cathode pixel structures.

31. The method of claim 21, wherein the one or more types of nuclei are ¹H¹⁺ nuclei and ¹¹B⁵⁺ nuclei in a one-to-one ratio and wherein the one or more resulting types of nuclei are ⁴He²⁺ nuclei in a three-to-one ratio to the ¹H¹⁺ nuclei and to the ¹¹B⁵⁺ nuclei.

32. A system comprising:
a capillary, wherein the capillary comprises a cavity within the capillary;
a pulsed magnetic field source configured to generate a magnetic field pulse within the cavity; and
an electric field source configured to generate an electric field within the cavity,
wherein:
the cavity is configured to receive one or more types of nuclei,
the magnetic field pulse and the electric field are configured to focalize the one or more types of nuclei and to cause the one or more types of nuclei to interact and to generate one or more resulting types of nuclei acquiring kinetic energy.

33. The system of claim 32, wherein the capillary and the cavity of the capillary, and wherein the magnetic field pulse and the electric field are configured to focalize the one or more types of nuclei along a cylindrical axis of the cavity of the capillary.

34. The system of claim 32, comprising at least one orifice at either a top or a bottom of the cavity, wherein the one or more types of nuclei are configured to enter into the cavity through the at least one orifice.

35. The system of claim 34, comprising electrodes above and below the orifice, wherein a voltage is applied between the electrodes generating another electric field between the electrodes, and wherein the other electric field is configured to remove electrons from one or more types of atoms entering the cavity to yield the one or more types of nuclei.

36. The system of claim 32, wherein the electric field is configured to remove electrons from one or more types of atoms entering the cavity to yield the one or more types of nuclei.

37. The system of claim 32, comprising at least one magnetic reflector around the cavity, wherein the at least one magnetic reflector is configured to reflect the magnetic field pulse within the cavity.

38. The system of claim 32, wherein the magnetic field pulse and the electric field are configured to bounded-chain focalize the one or more types of nuclei.

39. The system of claim 32, comprising:
one or more charge-coupled cathode pixel structures placed above and/or below the cavity,
wherein charge-coupled cathode pixel structures are configured to be stricken by the one or more resulting types of nuclei and to release electrons generating electricity.

40. The system of claim 39, comprising a load coupled to the one or more charge-coupled cathode pixel structures, and wherein the load is configured to receive the electricity.

41. The system of claim 32, wherein the one or more types of nuclei are ¹H¹⁺ nuclei and ¹¹B⁵⁺ nuclei in a one-to-one ratio and wherein the one or more resulting types of nuclei are ⁴He²⁺ nuclei in a three-to-one ratio to the ¹H¹⁺ nuclei and to the ¹¹B⁵⁺ nuclei.
